(19) United States
(12) Patent Application Publication
(10) Pub. No.: US 2026/0316162 A1
(43) Pub. Date: Oct. 15, 2026

(54) DRILL CHUCK AND DRILL

(71) Applicant: Roehm GmbH, Sontheim/Brenz (DE)

(72) Inventors: Peter SCHENK, Niederstotzingen (DE); Fabian MAYERLE, Blindheim (DE)

(73) Assignee: Roehm GmbH, Sontheim/Brenz (DE)

(21) Appl. No.: 19/700,675

(22) Filed: Jun. 8, 2026

Related U.S. Application Data
(63) Continuation of application No. PCT/EP2024/083381, filed on Nov. 25, 2024.

(30) Foreign Application Priority Data
Dec. 6, 2023 (DE) 10 2023 134 201.0

(51) Int. Cl. B23B 31/12

(52) U.S. Cl. CPC B23B 31/1207

(57) ABSTRACT

A drill chuck with a chuck body that has, at its rear end, a spindle receptacle and has, at its axially front end, a tool receptacle in which clamping jaws terminate that are displaceably guided in guide channels of the chuck body. At least one groove oriented radially with respect to the longitudinal axis of the chuck body extends forward in the axial direction from the axially rear end of the spindle receptacle, wherein a mating receptacle is formed staggered axially forward from the groove, and a passage extends from the mating receptacle to the tool receptacle. The invention further relates to a drill.

This nonprovisional application is a continuation of International Application No. PCT/EP 2024/083381, which was filed on Nov. 25, 2024, and which claims priority to German Patent Application No. 10 2023 134 201.0, which was filed in Germany on Dec. 6, 2023, and which are both herein incorporated by reference.

### BACKGROUND OF THE INVENTION

### Field of the Invention

The invention relates to a drill chuck with a chuck body that has, at its rear end, a spindle receptacle and has, at its axially front end, a tool receptacle in which clamping jaws terminate that are displaceably guided in guide channels of the chuck body, wherein at least one groove oriented radially with respect to the longitudinal axis of the chuck body extends forward in the axial direction from the axially rear end of the spindle receptacle, wherein a mating receptacle is formed staggered axially forward from the groove, and wherein a passage extends from the mating receptacle to the tool receptacle. The invention additionally relates to a drill.

### Description of the Background Art

A drill chuck is known from EP 0 710 518 A2, which corresponds to U.S. Pat. No. 5,765,839, which is incorporated herein by reference, and wherein this document, which describes the knowledge of the average person skilled in the art, can be referred to for the basic structure and mode of operation of the drill chuck.

DE 20 2013 101 255 U1, which corresponds to US 2014/0284888, which is incorporated herein by reference, discloses a drill chuck with a chuck body at the rear end of which is formed a spindle receptacle for coupling to the drill spindle of a drill, said receptacle having an internal thread into which the drill spindle with an external thread can be screwed. Axial retention of the drill chuck with respect to the drill spindle is provided by a passage formed in the chuck body through which a retaining screw can be screwed into a screw receptacle of the drill spindle.

Modern drills are becoming ever more powerful and can produce high torques greater than 200 Nm, which must be transmitted safely to the drill chuck without overloading the connection between the chuck body and the drill spindle or putting a later detachability at risk, which is to say while also permitting a replacement of the drill chuck. In particular, it is necessary to ensure that no breakage of the drill spindle occurs, since this could endanger the user if the drill chuck detaches from the drill during operation. Increasing the material thickness is not a feasible solution here because the outer diameter of the drill chuck should not exceed 43 mm, since this measurement is accepted in the industry and the dimensions are tailored to it.

### SUMMARY OF THE INVENTION

It is therefore an object of the present invention to provide a drill chuck that can transmit a high torque and at the same time also permits replacement of the drill chuck from a drill spindle by the user without the need to visit a service center. Another object is to provide a suitable drill for driving the drill chuck.

The drill chuck permits an improved transmission of force from the drill spindle of a drill because, instead of the widely used threaded connection between the drill spindle and the drill chuck being responsible for force transmission, the radial forces are now introduced into the chuck body through the groove, and the alignment of the spindle in the spindle receptacle is accomplished by the mating receptacle, by which means axial retention is simplified. The groove in this case need not extend radially to the outer edge of the chuck body, but can also be formed in the manner of a pocket. Owing to the design according to the invention, torques can be transmitted that are greater than 200 Nm. The axial retention of the spindle can be achieved by a retaining screw that extends from the tool receptacle through the passage to the spindle receptacle, where it can be screwed into a screw receptacle formed in the spindle.

It is advantageous in this case when the groove is provided in multiple instances in a uniformly distributed arrangement around the circumference, in particular when the groove is formed in duplicate in a diametrically opposed, radially oriented arrangement. This permits symmetrical torque transmission without active tilting moments with a mechanical design that is as simple as possible.

It is especially preferred here when the transition from the groove walls to the groove base is designed with a rounding. As a result of this rounding, an enlarged surface area is available for contact between the spindle receptacle and the spindle to be inserted there, which is associated with a reduced surface pressure and thus promotes the transmission of greater forces in the small space available. For the purpose of enlarging the surface area and thus reducing the surface pressure, the groove base has a radius or is designed with a radius that is between 25 mm and 55 mm, and preferably is 40 mm.

If the radial extent of the groove is larger than the radial extent of the mating receptacle, then the torque can be transmitted with a large leverage and nevertheless the spindle can be guided past the groove with its spindle axis centered and coaxial. Preferably, the diameter of the mating receptacle is 12 mm, since this permits an adequate remaining material thickness of the chuck body in the region with a good remaining thickness of the spindle.

The diameter of the passage can be smaller than the diameter of the mating receptacle so that the mating receptacle can also function as a stop, in particular when an internal thread is formed in the passage. This internal thread does not serve in this case to interact with and secure the spindle with respect to the chuck body, but instead permits on the one hand that the spindle can be pushed out of the spindle receptacle with a jack screw, which is especially advantageous when poor climatic conditions can cause corrosion to occur in the region of the interface between the spindle and the chuck body. On the other hand, this internal thread can be used for installation and machining of the drill chuck, since the thread that serves the retention of the spindle, which is otherwise used for these purposes, is not present. Considerable extra effort is avoided, particularly during grinding operations, because it is possible to dispense with the use of the retaining screw and its installation and removal.

If a countersink extending from the tool receptacle to the passage is formed staggered axially forward from the passage, the screw head of the retaining screw can be introduced there without interfering with the tools or workpieces to be introduced into the tool receptacle.

The transition from the outer surface of the chuck body in the region of the axially rear end of the spindle receptacle to a body disk forming parts of the guide channels is designed with a disk rounding, once again for the purpose of increasing the available surface area and thus reducing the surface pressure.

The diameter of the internal thread of the passage can be larger than the diameter of the retaining screw extending through the passage so that the retaining screw can be moved past the internal thread, unhindered by the same, when being screwed into the spindle.

It is very especially preferred when, in a drill with a drill spindle, a radially projecting wing is formed at a distance from the free end of the drill spindle, wherein the wing is present in duplicate in a diametically opposed arrangement and the end face of the free end of the drill spindle is designed as a plane face.

This permits the creation of a combination of a drill chuck of the aforementioned type with such a drill having a drill spindle, wherein the drill spindle has at least one radially projecting wing intended for insertion into the at least one groove, and the drill spindle has a spindle diameter matched to the mating receptacle for guidance therein.

In addition, a jack screw with an outer diameter matched to the diameter of the internal thread of the passage can be provided, by which means the drill spindle of the drill is pushed out of the spindle receptacle when the jack screw is screwed into the internal thread.

The features and combinations of features mentioned above in the description, as well as the features and combinations of features mentioned below in the figure description and/or shown only in the figures, can be used not only in the combination specified in each case, but also in other combinations or alone, without departing from the scope of the invention. Consequently, embodiments that are not explicitly shown in the figures or explained but that emerge from and can be produced from separate combinations of features from the explained embodiments should also be considered as encompassed by and disclosed by the invention.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a side view of a drill chuck, in a cutaway view,

FIG. 2 is an enlarged representation of the detail relating to the body shoulder in the region of the carrier groove from FIG. 1,

FIG. 3 is a representation corresponding to FIG. 1 of the drill chuck in combination with a spindle secured by a retaining screw,

FIG. 4 is a representation corresponding to FIG. 3 of the combination of the drill chuck with a grinding spindle, and

FIG. 5 is a representation corresponding to FIG. 1 of the combination of the drill chuck with a drill spindle of a drill, shown with a jack screw placed in position.

### DETAILED DESCRIPTION

FIG. 1 shows a drill chuck 1 with a chuck body 2 that has, at its rear end, a spindle receptacle 3 and has, at its axially front end, a tool receptacle 4 in which clamping jaws 6 terminate that are displaceably guided in guide channels 5 of the chuck body 2. At least one groove 8 oriented radially with respect to the longitudinal axis 7 of the chuck body 2 extends forward in the axial direction from the axially rear end of the spindle receptacle 3. The groove 8 can be provided in multiple instances in a uniformly distributed arrangement around the circumference. In the example shown, the groove 8 is formed in duplicate in a diametrically opposed, radially oriented arrangement.

A mating receptacle 9 is formed staggered axially forward from the groove 8, wherein a passage 10 extends from the mating receptacle 9 to the tool receptacle 4.

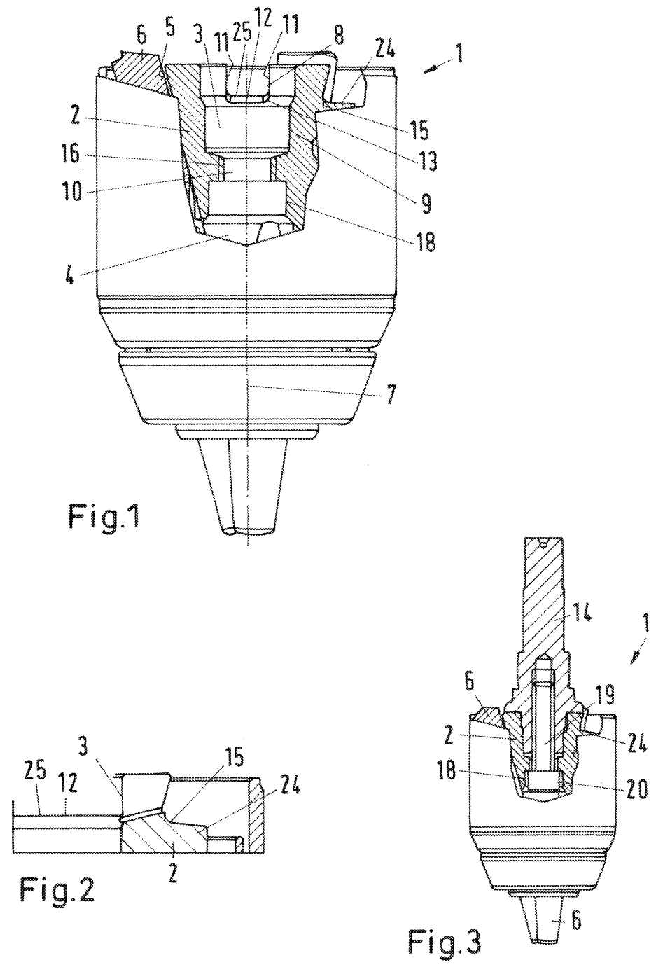

FIG. 2 shows that the transition from the groove walls 11 to the groove base 12 is designed in this case with a rounding 13 that serves to minimize the notch effect that acts in the groove 8. The groove base 12 itself is also rounded, designed with a radius 25 that is 40 mm in the example shown in the drawing. This radius 25 serves to enlarge the surface area in order to reduce the surface pressure. The radius 25 of 40 mm that is shown is especially well suited in this case, although the radius 25 can also take on values between 25 mm and 55 mm, in particular between 35 mm and 45 mm. A reduced surface pressure is also the motivation for the circumstance that the transition from the outer surface of the chuck body 2 in the region of the axially rear end of the spindle receptacle 3 to a body disk forming parts of the guide channels 5 is designed with a disk rounding 15.

The radial extent of the groove 8 is larger than the radial extent of the mating receptacle 9 in order to permit an insertion of the spindle 14 into the mating receptacle 9 and nevertheless to ensure an improved transmission of torque. The diameter of the mating receptacle 9 is 12 mm in the depicted example from FIG. 1.

The diameter of the passage 10 is smaller than the diameter of the mating receptacle 9, so that a stop for the end face of the spindle 14 is also provided. Formed in the passage 10 is an internal thread 16 that can be used for interaction with a jack screw 17, which is provided with an outer diameter matched to the diameter of the internal thread 16 of the passage 10. Consequently, the spindle 14 can be pushed axially out of the spindle receptacle 3 with the jack screw 17 as needed, for example for drill chuck replacement. Furthermore, the internal thread 16 can also be used for installation and machining purposes with regard to the drill chuck 1.

Staggered axially forward from the passage 10 is formed a countersink 18 that extends from the tool receptacle to the passage and serves to accommodate the screw head of a retaining screw (FIG. 1).

The diameter of the internal thread 16 of the passage 10 is larger than the diameter of the retaining screw 19 extending through the passage 10 in this case.

In order to provide a drill suitable for interaction with a drill chuck 1 of this nature, a drill with a drill spindle 21 has at least one radially projecting wing at a distance from the free end of the drill spindle 21, wherein the wing, with regard to the example shown, preferably is present in duplicate in a diametically opposed arrangement. The end face of the free end of the drill spindle 21 is designed as a plane face 22.

As a result, a combination of the drill chuck 1 and a drill having a drill spindle 21 can be created, wherein the drill spindle has at least one radially projecting wing intended for insertion into the at least one groove 8 and has a spindle diameter matched to the mating receptacle 9 for guidance therein.

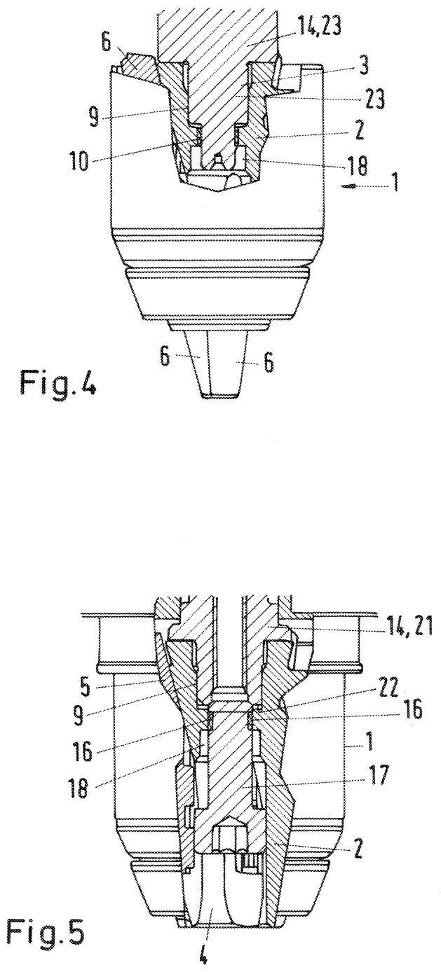

FIG. 3 shows how the spindle receptacle 3 is used for connection to a spindle 14, which is depicted in isolation, but can, as drill spindle 21, be designed as part of a drill or as a grinding spindle 23. For axial retention of the spindle 14 in the spindle receptacle 3, the retaining screw 19 is used, whose screw head 20 engages with the countersink 18 and which is located there. By means of the retaining screw 19, the plane face 22 of the spindle 14 is drawn against the chuck body in the region of the mating receptacle 9, thus defining the axial position. The radial position of the spindle 14 is determined by the mating receptacle 9. FIG. 4 shows the possibility that for lower stress, such as during placement of a grinding spindle 23 in the spindle receptacle 3, the passage 10 with its internal thread 16 can also be used for retention of the grinding spindle 23, which is to say no retaining screw 19 need then be installed and removed.

After removal of the retaining screw 19, access to the passage 10 with the internal thread 16 is exposed. By means of a jack screw 17 screwed into the internal thread 16, the drill spindle 21 can be pushed axially out of the spindle receptacle 3 (FIG. 5).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A drill chuck comprising:
a chuck body that has, at its rear end, a spindle receptacle and has, at its axially front end, a tool receptacle in which clamping jaws terminate that are displaceably guided in guide channels of the chuck body;
at least one groove is oriented radially with respect to a longitudinal axis of the chuck body and extends forward in an axial direction from the axially rear end of the spindle receptacle;
a mating receptacle being formed staggered axially forward from the groove; and
a passage that extends from the mating receptacle to the tool receptacle.

2. The drill chuck according to claim 1, wherein the groove is provided in multiple instances in a uniformly distributed arrangement around the circumference.

3. The drill chuck according to claim 2, wherein the groove is formed in duplicate in a diametrically opposed, radially oriented arrangement.

4. The drill chuck according to claim 1, wherein a transition from the groove walls to the groove base is designed with a rounding.

5. The drill chuck according to claim 1, wherein the groove base is designed with a radius.

6. The drill chuck according to claim 1, wherein the radial extent of the groove is larger than the radial extent of the mating receptacle.

7. The drill chuck according to claim 1, wherein a diameter of the mating receptacle is 12 mm.

8. The drill chuck according to claim 1, wherein a diameter of the passage is smaller than the diameter of the mating receptacle.

9. The drill chuck according to claim 1, wherein an internal thread is formed in the passage.

10. The drill chuck according to claim 1, wherein a countersink extending from the tool receptacle to the passage is formed staggered axially forward from the passage.

11. The drill chuck according to claim 1, wherein the transition from the outer surface of the chuck body in a region of the axially rear end of the spindle receptacle to a body disk forming parts of the guide channels is designed with a disk rounding.

12. The drill chuck according to claim 9, wherein the diameter of the internal thread of the passage is larger than the diameter of a retaining screw extending through the passage.

13. The drill chuck according to claim 1, wherein, in combination with a drill having a drill spindle, characterized in that the drill spindle has at least one radially projecting wing intended for insertion into the at least one groove, and wherein the drill spindle has a spindle diameter matched to the mating receptacle for guidance therein.

14. The drill chuck according to claim 9, wherein a jack screw with an outer diameter is matched to a diameter of the internal thread of the passage.

15. A drill comprising a drill spindle, wherein a radially projecting wing is formed at a distance from the free end of the drill spindle.

16. The drill according to claim 15, wherein the wing is present in duplicate in a diametically opposed arrangement, and wherein an end face of a free end of the drill spindle is designed as a plane face.
